(19) United States
(12) Patent Application Publication
(10) Pub. No.: US 2013/0330083 A1
(43) Pub. Date: Dec. 12, 2013

(54) UNDERWATER COMMUNICATION APPARATUS AND METHOD

(71) Applicants: Yong Gwan Kim, Seoul (KR); KOREA INSTITUTE OF SCIENCE AND TECHNOLOGY, Seoul (KR)

(72) Inventors: Jin-Dong SONG, Seoul (KR); Il Ki HAN, Seoul (KR); Won Jun CHOI, Seoul (KR); Jung Il LEE, Seoul (KR)

(73) Assignee: KOREA INSTITUTE OF SCIENCE AND TECHNOLOGY, Seoul (KR)

(21) Appl. No.: 13/744,564

(22) Filed: Jan. 18, 2013

(30) Foreign Application Priority Data
Jan. 18, 2012 (KR) 10-2012-0005832

(51) Int. Cl. H04B 10/80

(52) U.S. Cl. CPC H04B 10/80
USPC 398/104

(57) ABSTRACT

An underwater communication apparatus for performing an optical communication with an external device under water includes: a current control unit that modulates first data to be transmitted to the external device into a first current; and a light transmitting unit that transmits light with a wavelength of 450 to 500 nm corresponding to the first current to the external device.

### CROSS-REFERENCE TO RELATED PATENT APPLICATION

This application claims the benefit of Korean Patent Application No. 10-2012-0005832, filed on Jan. 18, 2012, in the Korean Intellectual Property Office, the disclosure of which is incorporated herein in its entirety by reference.

### BACKGROUND OF THE INVENTION

1. Field of the Invention

The present invention relates to an underwater communication apparatus and method which performs a communication with an external device under water, and more particularly, to an underwater communication apparatus and method which performs a communication by using light with a wavelength of 450 to 500 nm and a low absorptance

2. Description of the Related Art

Since an electric wave communication including a general band may not be performed under water, a wired communication or a communication using ultrasound waves or extremely low-frequency waves is used. Accordingly, underwater operators or scuba divers may perform a wired communication by being connected to one another or a wireless communication by using ultrasound waves.

A wired communication has disadvantages in that since a length of a communication line is limited, activities of an operator are limited, and costs for manufacturing the communication line are increased.

A wireless communication using ultrasound waves have advantages in that activities of an operator are freer than those of operators in a wired communication. However, the wireless communication using ultrasound waves have disadvantages in that in order to perform a communication by using ultrasound waves, an intermediate transmission device has to be installed on a surface of a water and the operator should not be separated by about 500 m or more from the intermediate transmission device. Also, the wireless communication using ultrasound waves of, for example, 32 kHz, have disadvantages in that various data may not be transmitted by using the ultrasound waves of 32 kHz, and voice data may be distorted because 32 kHz is not a frequency equal to or greater than a double of an audible frequency (of, for example, 20 to 20000 Hz).

Accordingly, there is a demand for a method of efficiently performing a communication under water.

### SUMMARY OF THE INVENTION

The present invention provides an underwater communication apparatus and method which may transmit data under water without distortion by using light with a wavelength of 450 to 500 nm and a low absorptance. Also, the present invention provides an underwater communication apparatus and method which may transmit various data such as text data or image data as well as voice data.

According to an aspect of the present invention, there is provided an underwater communication apparatus for performing an optical communication with an external device under water, the underwater communication apparatus including: a current control unit that modulates first data to be transmitted to the external device into a first current; and a light transmitting unit that transmits light with a wavelength of 450 to 500 nm corresponding to the first current to the external device.

The first data may include at least one of image data, voice data, and text data.

The underwater communication apparatus may further include a data transmitting unit that transmits the first data to the current control unit, wherein the data transmitting unit includes at least one of a microphone, a camera, a text input device, a body information collecting device, and an environment information collecting device.

The light transmitting unit may include a light-emitting diode (LED).

The light transmitting unit may transmit light having a longer wavelength as a transparency of a water adjacent to the underwater communication apparatus is reduced.

According to another aspect of the present invention, there is provided an underwater communication apparatus for performing an optical communication with an external device under water, the underwater communication apparatus including: a light detecting unit that detects light with a wavelength of 450 to 500 nm received from the external device and generates a second current; and a current control unit that demodulates the second current into second data.

The second data may include at least one of image data, voice data, and text data.

The underwater communication apparatus may further include a data reproducing unit that reproduces the second data, wherein the data reproducing unit includes at least one of a speaker and a display unit.

The light received from the external device may include light-emitting diode (LED) light.

The underwater communication apparatus may further include a control unit that detects a direction in which the light is received from the external device and obtains position information of the external device.

According to another aspect of the present invention, there is provided an underwater communication method of performing an optical communication with an external device under water, the underwater communication method including: modulating first data to be transmitted to the external device into a first current; and transmitting light with a wavelength of 450 to 500 nm corresponding to the first current to the external device.

The first data may include at least one of image data, voice data, and text data.

The light may include light-emitting diode (LED) light.

The transmitting of the light to the external device may include transmitting light having a longer wavelength as a transparency of water adjacent to an underwater communication apparatus is reduced.

According to another aspect of the present invention, there is provided an underwater communication method of performing an optical communication with an external device under water, the underwater communication method including: detecting light with a wavelength of 450 to 500 nm received from the external device and generating a second current; and demodulating the second current into second data.

The second data may include at least one of image data, voice data, and text data.

The underwater communication method may further include transmitting the second data to at least one of a speaker and a display unit.

The light received from the external device may include light-emitting diode (LED) light.

The underwater communication method may further include detecting a direction in which the light is received from the external device and obtaining position information of the external device.

According to another aspect of the present invention, there is provided a computer-readable recording medium having embodied thereon a program for executing the underwater communication method.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph illustrating a relationship between an absorptance of seawater and a wavelength of light;

FIG. 2 is a block diagram illustrating an underwater communication apparatus according to an embodiment of the present invention;

FIG. 3 is a block diagram illustrating the underwater communication apparatus according to another embodiment of the present invention;

FIG. 4A is a block diagram illustrating an underwater communication apparatus according to another embodiment of the present invention;

FIG. 4B is a block diagram illustrating the underwater communication apparatus according to another embodiment of the present invention;

FIG. 5 is a view for explaining a process of performing an underwater communication by using the underwater communication apparatus, according to an embodiment of the present invention;

FIG. 6 is a flowchart illustrating an underwater communication method according to an embodiment of the present invention; and

FIG. 7 is a flowchart illustrating an underwater communication method according to another embodiment of the present invention.

### DETAILED DESCRIPTION OF THE INVENTION

Expressions such as “at least one of,” when preceding a list of elements, modify the entire list of elements and do not modify the individual elements of the list.

The present invention now will be described more fully hereinafter with reference to the accompanying drawings, in which elements of the invention are shown. The present invention may, however, be embodied in many different forms and should not be construed as limited to the exemplary embodiments set forth herein. Rather, these embodiments are provided so that this disclosure will be thorough and complete, and will fully convey the scope of the present invention to one of ordinary skill in the art. Throughout, like reference numerals denote like elements.

The term “unit” in the embodiments of the present invention means a software component or hardware components such as a field-programmable gate array (FPGA) or an application-specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units”, or may be divided into additional components and “units”.

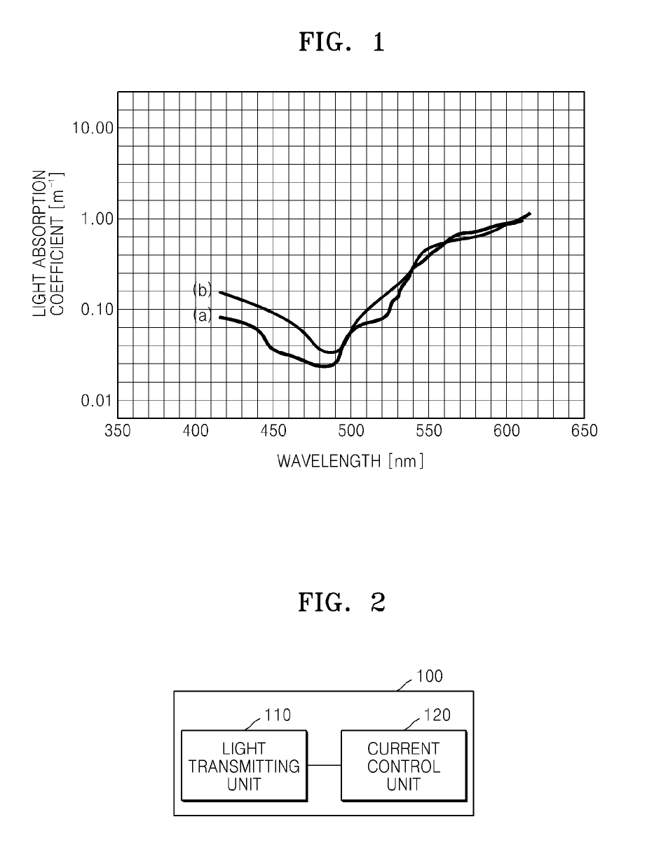

FIG. 1 is a graph illustrating a relationship between an absorptance of a seawater and a wavelength of light.

Referring to FIG. 1, a seawater rarely absorbs light with a wavelength of 450 to 500 nm. Accordingly, an underwater communication apparatus according to an embodiment of the present invention may transmit data without distortion by using light with a wavelength of 450 to 500 nm.

FIG. 2 is a block diagram illustrating an underwater communication apparatus 100 according to an embodiment of the present invention.

Referring to FIG. 2, the underwater communication apparatus 100 may include a current control unit 120 and a light transmitting unit 110.

The current control unit 120 modulates first data to be transmitted to an external device into a first current. Examples of a modulation method performed by the current control unit 120 include a baseband modulation method that performs a modulation in a baseband, and a subcarrier modulation method that uses subcarrier waves. Examples of the baseband modulation method include a pulse modulation method that uses characteristics (e.g., a position, a width, and an interval) of a pulse(s) and a line coding scheme, and examples of the subcarrier modulation method include an M-ary phase-shift keying modulation method, a pulse-amplitude modulation method, a quadrature amplitude modulation method, and an on-off keying modulation method.

The first data may include at least one of image data, voice data, and text data.

The light transmitting unit 110 transmits light corresponding to the first current to the external device. The light transmitting unit 110 may transmit light with a wavelength of 450 to 500 nm which is rarely absorbed under water.

The first current is turned on/off or has its intensity changed to correspond to the first data. By turning on/off light or changing an intensity of the light by using the first current, the light transmitting unit 110 may transmit the first data to the external device.

The light transmitting unit 110 may include a light-emitting diode (LED). Since a communication may be performed within a usable range of the LED of the light transmitting unit 110, the LED has high security, is harmless to a human body, and has no restriction to a band. Also, the LED has lower power consumption and a longer life time and is more environment-friendly than other light sources.

A curve ‘a’ of FIG. 1 shows a result obtained by measuring a light absorption coefficient in a seawater A, and a curve ‘b’ of FIG. 1 shows a result obtained by measuring a light absorption coefficient in a seawater B. By referring to the curves ‘a’ and ‘b’, it is found that as a transparency of a seawater is reduced, light having a longer wavelength is not absorbed. Accordingly, the light transmitting unit 110 may transmit light having a longer wavelength as a transparency of a seawater adjacent to the underwater communication apparatus 100 is reduced.

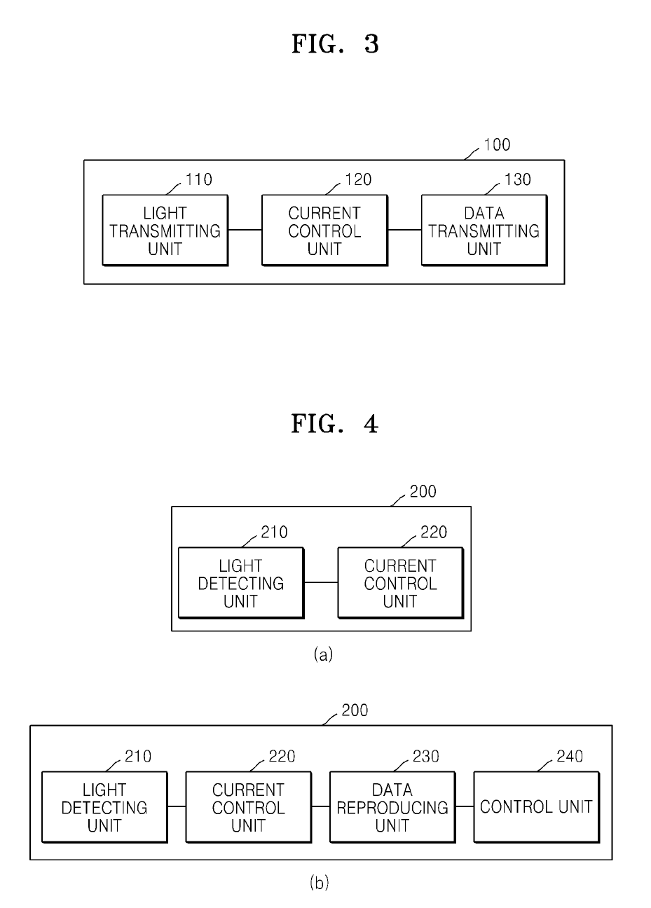

FIG. 3 is a block diagram illustrating the underwater communication apparatus 100 according to another embodiment of the present invention.

Referring to FIG. 3, the underwater communication apparatus 100 may further include a data transmitting unit 130 in addition to the light transmitting unit 110 and the current control unit 120 of the underwater communication apparatus 100 of FIG. 2.

The data transmitting unit 130 transmits the first data to the current control unit 120. The data transmitting unit 130 may include at least one of a microphone, a camera, a text input device, a body information collecting device, and an environment information collecting device.

That is, an underwater operator may transmit to the external device through the current control unit 120 and the light transmitting unit 110 voice data input by using a microphone, image data (e.g., image data or video data) obtained by using a camera, or text data input by using a text input device (e.g., a keyboard or a text input terminal). The underwater communication apparatus 100 may transmit image data or text data as well as voice data, when compared with an ultrasound communication that transmits only voice data.

Also, body information including a pulse, a temperature, etc. of the underwater operator obtained by using a body information collecting device, or environment information including an underwater temperature, an underwater pressure, etc. obtained by using an environment information collecting device may be transmitted to the external device through the current control unit 120 and the light transmitting unit 110. Accordingly, when an urgent event occurs, a rescue request may be quickly transmitted to the outside.

The data transmitting unit 130 may further include a memory, store data in the memory above ground, and transmit the data stored in the memory under water.

FIG. 4A is a block diagram illustrating an underwater communication apparatus 200 according to another embodiment of the present invention.

Referring to FIG. 4A, the underwater communication apparatus 200 may include a light detecting unit 210 and a current control unit 220.

The light detecting unit 210 includes a light sensor, and generates second current by detecting light with a wavelength of 450 to 500 nm received from the external device. The second current may include second data received from the external device, and the second data may include at least one of image data, voice data, and text data. Also, the light detecting unit 210 may detect LED light received from the external device. The current control unit 220 demodulates the second current into the second data. The current control unit 220 uses a demodulation method corresponding to the modulation method performed by the current control unit 120 described with reference to FIG. 2.

FIG. 4B is a block diagram illustrating the underwater communication apparatus 200 according to another embodiment of the present invention.

Referring to FIG. 47B, the underwater communication apparatus 200 may further include a data reproducing unit 230 or a control unit 240 in addition to the light detecting unit 210 and the current control unit 220 of the underwater communication apparatus 200 of FIG. 4A.

The data reproducing unit 230 reproduces the second data obtained by the current control unit 220. That is, the data reproducing unit 230 reproduces text data, voice data, or image data, and displays the reproduced text data, voice data, or image data to the underwater operator. The term ‘reproducing’ used herein refers to executing each data according to a format of the data.

The data reproducing unit 230 may include at least one of a speaker and a display unit, but the present embodiment is not limited thereto. Text data or image data may be displayed to the underwater operator by using a display unit, and voice data may be transmitted to the underwater operator by using a speaker.

The control unit 240 detects a direction in which light is received from the external device and obtains position information of the external device. The control unit 240 may determine a position of the external device that transmits corresponding data by using information about a direction in which light is received by the light detecting unit 210.

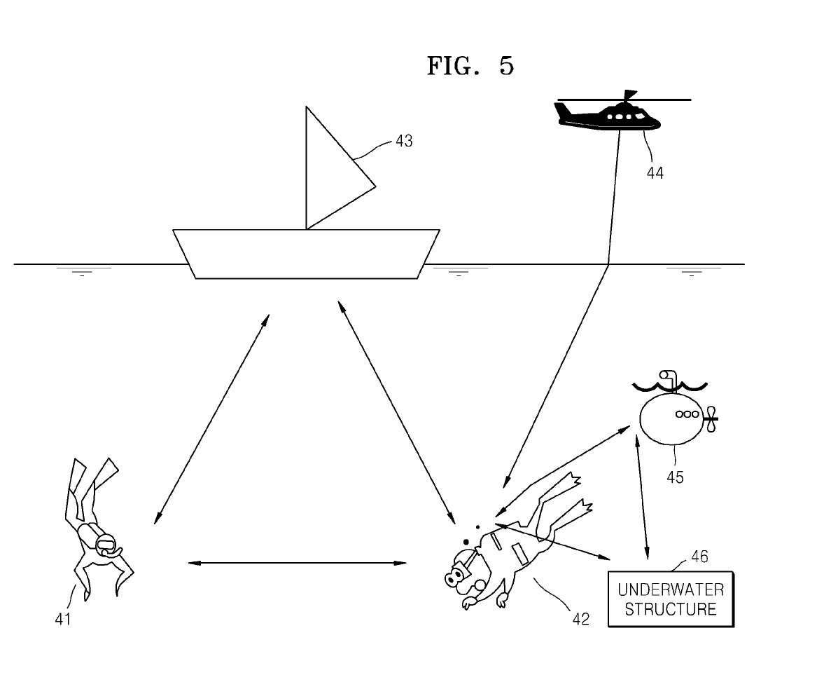

FIG. 5 is a view for explaining a process of performing an underwater communication by using the underwater communication apparatus 100 or 200, according to an embodiment of the present invention.

By using the underwater communication apparatus 100 or 200, an underwater operator 41 may perform an underwater communication with another underwater operator 42, and may also perform a communication with a ship 43 or an airplane 44 on or over a surface of a water. Also, the underwater operator 41 or 42, a submarine 45, the ship 43, or the airplane 44 may perform an underwater communication in order to transmit data to an underwater structure 46 other than an underwater operator.

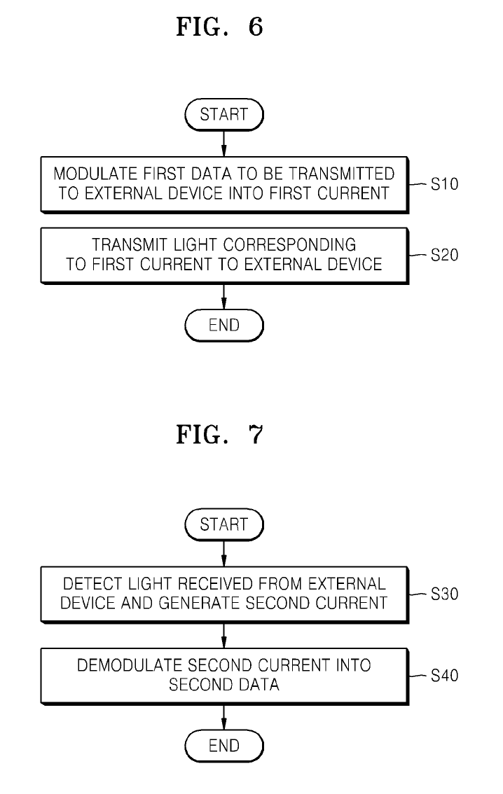

FIG. 6 is a flowchart illustrating an underwater communication method according to an embodiment of the present invention.

Referring to FIG. 6, the underwater communication method includes operations sequentially performed by the underwater communication apparatus 100 of FIG. 2. Accordingly, although omitted, descriptions already made for the underwater communication apparatus 100 of FIG. 2 may apply to the underwater communication method of FIG. 6.

In operation S10, the current control unit 120 modulates first data to be transmitted to an external device into a first current. The first data may include at least one of image data, voice data, and text data.

In operation S20, the light transmitting unit 110 transmits light with a wavelength of 450 to 500 nm corresponding to the first current to the external device. The light transmitting unit 110 may transmit LED light.

For example, when an underwater operator is to transmit image data to the external device, the current control unit 120 may modulate the image data into a first current, and the light transmitting unit 110 may transmit the image data to the external device by changing an intensity of light or turning on/off the light by using the first current.

FIG. 7 is a flowchart illustrating an underwater communication method according to another embodiment of the present invention. Referring to FIG. 7, the underwater communication method includes operations sequentially performed by the underwater communication apparatus 200 of FIG. 4. Accordingly, although omitted, descriptions already made for the underwater communication apparatus 200 of FIG. 4 may apply to the underwater communication method of FIG. 7.

In operation S30, the light detecting unit 210 detects light with a wavelength of 450 to 500 nm received from an external device and generates a second current. The second current includes second data. The light received from the external device may include LED light.

In operation s40, the current control unit 220 demodulates the second current into the second data. The second data may include at least one of image data, voice data, and text data. The second data may be transmitted to at least one of a speaker and a display unit to be reproduced.

For example, when light including image data is received from the external device, the light detecting unit 210 may generate a current corresponding to the image data by detecting the received light, and the current control unit 220 may generate the image data by demodulating the current.

The present invention may be embodied as a program executed in a computer, and may be implemented in a general purpose digital computer by using a computer-readable medium.

Examples of the computer-readable medium include storage media such as magnetic storage media (e.g., read only memories (ROMs), floppy discs, or hard discs), optically readable media (e.g., compact disk-read only memories (CD-ROMs), or digital versatile disks (DVDs)), etc.

An underwater communication apparatus and method according to the present invention may transmit data without distortion by using light with a wavelength of 450 to 500 nm and a low absorptance under water.

Also, the underwater communication apparatus and method according to the present invention may transmit various data such as text data or image data as well as voice data.

While the present invention has been particularly shown and described with reference to exemplary embodiments thereof using specific terms, the embodiments and terms have been used to explain the present invention and should not be construed as limiting the scope of the present invention defined by the claims. Accordingly, it will be understood by those of ordinary skill in the art that various changes in form and details may be made therein without departing from the spirit and scope of the present invention as defined by the following claims.

What is claimed is:

1. An underwater communication apparatus for performing an optical communication with an external device under water, the underwater communication apparatus comprising:
a current control unit that modulates first data to be transmitted to the external device into a first current; and
a light transmitting unit that transmits light with a wavelength of 450 to 500 nm corresponding to the first current to the external device.

2. The underwater communication apparatus of claim 1, wherein the first data comprises at least one of image data, voice data, and text data.

3. The underwater communication apparatus of claim 1, further comprising a data transmitting unit that transmits the first data to the current control unit,
wherein the data transmitting unit comprises at least one of a microphone, a camera, a text input device, a body information collecting device, and an environment information collecting device.

4. The underwater communication apparatus of claim 1, wherein the light transmitting unit comprises a light-emitting diode (LED).

5. The underwater communication apparatus of claim 1, wherein the light transmitting unit transmits light having a longer wavelength as a transparency of a water adjacent to the underwater communication apparatus is reduced.

6. An underwater communication apparatus for performing an optical communication with an external device under water, the underwater communication apparatus comprising:
a light detecting unit that detects light with a wavelength of 450 to 500 nm received from the external device and generates a second current; and
a current control unit that demodulates the second current into second data.

7. The underwater communication apparatus of claim 6, wherein the second data comprises at least one of image data, voice data, and text data.

8. The underwater communication apparatus of claim 6, further comprising a data reproducing unit that reproduces the second data,
wherein the data reproducing unit comprises at least one of a speaker and a display unit.

9. The underwater communication apparatus of claim 6, wherein the light received from the external device comprises light-emitting diode (LED) light.

10. The underwater communication apparatus of claim 6, further comprising a control unit that detects a direction in which the light is received from the external device and obtains position information of the external device.

11. An underwater communication method of performing an optical communication with an external device under water, the underwater communication method comprising:
modulating first data to be transmitted to the external device into a first current; and
transmitting light with a wavelength of 450 to 500 nm corresponding to the first current to the external device.

12. The underwater communication method of claim 11, wherein the first data comprises at least one of image data, voice data, and text data.

13. The underwater communication method of claim 11, wherein the light comprises light-emitting diode (LED) light.

14. The underwater communication method of claim 11, wherein the transmitting of the light to the external device comprises transmitting light having a longer wavelength as a transparency of a water adjacent to an underwater communication apparatus is reduced.

15. An underwater communication method of performing an optical communication with an external device under water, the underwater communication method comprising:
detecting light with a wavelength of 450 to 500 nm received from the external device and generating a second current; and
demodulating the second current into second data.

16. The underwater communication method of claim 15, wherein the second data comprises at least one of image data, voice data, and text data.

17. The underwater communication method of claim 15, further comprising transmitting the second data to at least one of a speaker and a display unit.

18. The underwater communication method of claim 15, wherein the light received from the external device comprises light-emitting diode (LED) light.

19. The underwater communication method of claim 15, further comprising detecting a direction in which the light is received from the external device and obtaining position information of the external device.

20. A computer-readable recording medium having embodied thereon a program for executing the underwater communication method of claim 11.
